(19) United States
(12) Patent Application Publication
(10) Pub. No.: US 2022/0176861 A1
(43) Pub. Date: Jun. 9, 2022

(54) LIFTING DEVICE MOUNTED TO A VEHICLE

(71) Applicant: Cornerstone Manufacturing Company LLC, Marshville, NC (US)

(72) Inventor: Ernest Scott HAIGLER, Marshville, NC (US)

(21) Appl. No.: 17/541,974

(22) Filed: Dec. 3, 2021

Related U.S. Application Data
(60) Provisional application No. 63/121,672, filed on Dec. 4, 2020.

(51) Int. Cl. B60P 1/44; B66F 7/12; B66F 7/28

(52) U.S. Cl. CPC B60P 1/4442; B60P 1/4471; B66F 7/28; B66F 7/12

(57) ABSTRACT

A lifting device for mounting to a vehicle includes a lifting surface having dimensions that fit a cargo area of the vehicle, the lifting surface being configured to carry a cargo; a telescoping assembly coupled to the vehicle and configured to horizontally extend by telescoping further than the vehicle; a lifting mechanism coupled to the telescoping assembly and to the lifting surface, the lifting mechanism being configured to move the lifting surface vertically to lift or lower the lifting surface. The lifting device further includes an actuating assembly in communication with the telescoping assembly and the lifting mechanism, the actuating assembly being configured to actuate the telescoping assembly to move horizontally in and out of the cargo area of the vehicle and to actuate the lifting mechanism to move vertically down to a loading surface and up to the cargo area of the vehicle.

### CROSS REFERENCE TO RELATED APPLICATIONS

The present patent application claims priority benefit from U.S. provisional patent application No. 63/121,672, filed on Dec. 4, 2020, the entire content of which is incorporated herein by reference.

### TECHNICAL FIELD

The present invention relates to lifting devices, and more specifically, to a lifting device mountable to a vehicle.

### BACKGROUND

Moving and transferring cargo in and out of a vehicle is a daily activity in many industries and in personal use. It can involve lifting heavy and cumbersome cargo into and out of a vehicle. Cargo can be lifted with a conventional independent forklift or an independent conventional scissor lift to a bed of a truck. Sometimes lifts are mounted to the vehicle, such as, wheelchair lifts that are used to lift a wheelchair into and out of the vehicle.

These existing options can be complicated, cumbersome and limited in use. There remains a need for improved lifting devices of the type that can be mounted to a vehicle for ready-access and convenience, as well as, improved lifting capabilities.

### BRIEF SUMMARY OF THE INVENTION

An aspect of the present invention is to provide a lifting device for mounting to a vehicle. The lifting device includes a lifting surface having dimensions that fit a cargo area of the vehicle, the lifting surface being configured to carry a cargo; a telescoping assembly coupled to the vehicle and configured to horizontally extend by telescoping further than the vehicle; a lifting mechanism coupled to the telescoping assembly and to the lifting surface, the lifting mechanism being configured to move the lifting surface vertically to lift or lower the lifting surface; and an actuating assembly in communication with the telescoping assembly and the lifting mechanism, the actuating assembly being configured to actuate the telescoping assembly to move horizontally in and out of the cargo area of the vehicle and to actuate the lifting mechanism to move vertically down to a loading surface and up to the cargo area of the vehicle.

In an embodiment, the lifting device further includes a contact sensor positioned at a tail end of the cargo area of the vehicle or at a back end of the lifting surface, or both, and in electrical communication with the actuating assembly, the contact sensor being configured and arranged to detect when an object is caught at a pinch area between an edge of the tail end and an edge of the back end of the lifting surface.

In an embodiment, when the contact sensor detects that the object is caught at the pinch area between the edge of the tail end and the edge of the back end of the lifting surface by detecting a force exerted on the contact sensor, the actuating assembly receives an electrical signal from the contact sensor to reverse movement by a predetermined amount to relieve the force and allow the object to be removed from the pinch area. In an embodiment, the contact sensor includes a micro-switch, a limit-switch, an electromechanical sensor, or a piezoelectric sensor, or any combination thereof.

In an embodiment, the lifting surface is made from metal, wood or plastic, or any combination thereof. In an embodiment, the lifting mechanism has a plurality of vertically telescoping posts or a pair of scissor arms. In an embodiment, the lifting device further includes a complement surface portion configured to move together with the lifting surface substantially horizontally and configured to separate from the lifting surface when the lifting surface moves vertically.

In an embodiment, the lifting device further includes a safety mechanism attached to the telescoping assembly and the lifting surface to prevent the lifting surface from detaching from the telescoping assembly in case of failure of the lifting mechanism. In an embodiment, the lifting mechanism includes a plurality of vertically telescoping posts, and wherein the safety mechanism includes a plurality of straps or cables attached to the telescoping assembly via a centrifugal clutch coupled to the telescoping assembly and to the lifting surface, wherein the plurality of straps or cables are configured to apply a lifting force by engaging the centrifugal clutch due to acceleration of the lifting surface due to gravity in an event of a break or accidental release or failure of one or more of the plurality of straps or cables within the plurality of vertically telescoping posts to prevent release of the lifting surface from the telescoping assembly. In an embodiment, the lifting mechanism includes a plurality of vertically telescoping posts having provided therein a plurality of cables or straps pulled or released by the actuating assembly to extend or retract the plurality of vertically telescoping posts.

In an embodiment, the lifting device further includes a dampening mechanism coupled to the telescoping assembly, the dampening mechanism being configured to dampen a translation of the telescoping assembly. In an embodiment, the dampening mechanism has a plurality of linear or rotary dampeners or both coupled to the telescoping assembly and configured and arranged to soften a speed or an amount of extension or retraction of the telescoping assembly to reduce an inertial force due to any heavy load provided on the lifting surface. In an embodiment, the plurality of linear or rotary dampeners coupled to the telescoping assembly are configured and arranged to soften a speed or an amount of extension of retraction during braking of an extension movement or during acceleration of the extension movement of the telescoping assembly.

In an embodiment, the lifting device further includes a pressure sensor provided underneath the lifting surface, the pressure sensor being in electrical communication with the actuating assembly, the pressure sensor being configured to contact an object or the loading surface or both. In an embodiment, when the pressure sensor comes in contact with the loading surface or the object the pressure sensor sends an electrical signal to the actuating assembly to stop a lowering movement of the lifting mechanism.

In an embodiment, the pressure sensor includes a plurality of pressure sensitive elements arranged underneath the lifting surface, wherein the plurality of pressure sensitive elements are in communication with a logic controller and when a first pressure sensitive elements in the plurality of pressure sensitive elements touches the loading surface while a second pressure sensitive element in the plurality of pressure sensitive elements does not touch the loading surface, a determination is made by the logic controller that the lifting surface is not evenly contacting the loading surface and an alert message is emitted by the logic controller.

In an embodiment, the pressure sensor includes a plurality of pressure sensitive elements arranged underneath the lifting surface, wherein the plurality of pressure sensitive elements are in communication with a logic controller and when a first pressure sensitive elements in the plurality of pressure sensitive elements touches the loading surface while a second pressure sensitive element in the plurality of pressure sensitive elements does not touch the loading surface, a determination is made by the logic controller that the lifting surface is not evenly contacting the loading surface and the logic controller sends an electromagnetic signal to the actuating assembly to stop the lowering movement of the lifting mechanism.

Another aspect of the present invention is to provide a method of loading or unloading cargo into and from a vehicle using a lifting device. The method includes opening a cargo area of the vehicle housing a lifting device by moving a gate to expose a lifting surface of the lifting device; moving the lifting surface of the lifting device substantially horizontally to extend the lifting surface out of the cargo area of the vehicle; moving the lifting surface of the lifting device substantially vertically down to a loading surface; resting the lifting surface of the lifting device on the loading surface; and loading or unloading cargo to or from the lifting surface.

In an embodiment, moving the lifting surface of the lifting device substantially horizontally includes actuating a telescoping assembly of the lifting device using an actuating assembly of the lifting device. In an embodiment, moving the lifting surface of the lifting device substantially horizontally includes moving the lifting surface out of the cargo area of the vehicle and out of a rear end of the vehicle or a lateral side of the vehicle. In an embodiment, moving the lifting surface of the lifting device substantially vertically includes actuating a lifting mechanism to move vertically down the lifting surface. In an embodiment, opening the cargo area of the vehicle housing the lifting device by moving the gate includes lowering the gate located at a back or a side of the vehicle.

In an embodiment, the method also includes, after resting the lifting surface of the lifting device on the loading surface, sensing that the lifting surface touches evenly the loading surface using a plurality of sensors provided at different locations on the lifting surface. In an embodiment, the method also includes raising up the lifting surface to a level of the cargo area of the vehicle and moving horizontally the lifting surface to the cargo area of the vehicle.

In an embodiment, the method further includes moving a complement surface portion along with the lifting surface substantially horizontally until the complement surface portion reaches the gate, and resting the complement surface portion on top of the gate while continue moving the lifting surface vertically.

Additional features, advantages, and embodiments of the invention are set forth or apparent from consideration of the following detailed description, drawings and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

FIG. 1 is a perspective view of a lifting device mounted to a vehicle, according to an embodiment of the present invention.

FIG. 2 is an enlarged perspective view of the lifting device shown in FIG. 1 at a tail end of the cargo area.

FIG. 3 is an enlarged perspective view of a portion of the lifting device shown in FIG. 1 showing details of a safety mechanism.

FIG. 4A is an enlarged perspective view of a portion of the lifting device shown in FIG. 1 showing details of a dampening mechanism.

FIG. 4B is a perspective view of an example of a dampening mechanism, according to an embodiment of the present invention.

FIG. 4C is a perspective view of another example of a dampening mechanism, according to an embodiment of the present invention.

FIG. 5 is a perspective view of a lifting device mounted to a vehicle, the lifting device provided with a pressure sensor, according to an embodiment of the present invention.

FIG. 6A is a perspective view of the lifting device mounted to the vehicle showing the lifting device tucked or stowed within the cargo area of the vehicle when not in use, stationary or before deployment.

FIG. 6B is a perspective view of the lifting device mounted to the vehicle showing the initial state for deploying the lifting device, wherein, for example, the cargo area is opened by rotating or lowering the tail gate of the vehicle to expose the lifting device and enable the lifting surface to move out of the cargo area of the vehicle.

FIG. 6C is a perspective view of the lifting device mounted to the vehicle showing an intermediate state for deploying the lifting device, wherein, for example, the lifting surface is moved horizontally to extend out of the cargo area of the vehicle.

FIG. 6D is a perspective view of the lifting device mounted to the vehicle showing a final state, i.e., loading or unloading state, where the lifting surface of the lifting device is brought to contact a loading surface to enable loading the cargo to the lifting surface or unloading the cargo from the lifting surface.

FIG. 7 is a flow chart of a method of loading or unloading cargo into or from a vehicle using a lifting device, according to an embodiment of the present invention.

FIG. 8 is a perspective view of a lifting device mounted to a vehicle showing an actuating assembly of the lifting device, according to an embodiment of the present invention.

FIG. 9 is a perspective view of a lifting surface of the lifting device showing a pressure sensor mounted to a bottom of the lifting surface, according to an embodiment of the present invention.

FIG. 10 is perspective top view of the lifting device mounted to a vehicle, according to an embodiment of the present invention.

FIG. 11 is a perspective view of the lifting device mounted to a vehicle showing the actuating assembly including a motor and one or more winches, according to an embodiment of the present invention.

FIG. 12 is schematic view of the actuating assembly including the motor and the one or more winches and one or more cables connected to the one or more winches, according to an embodiment of the present invention.

FIG. 13 is a perspective view of the lifting device mounted to a vehicle, the lifting device including dampening mechanism shown in FIG. 4B, according to an embodiment of the present invention.

FIG. 14 is a perspective view of the lifting device mounted to a vehicle, the lifting device including dampening mechanism shown in FIG. 4C, according to an embodiment of the present invention.

FIG. 15 is a perspective view of the lifting device showing details of the safety mechanism, according to an embodiment of the present invention.

FIG. 16 is an enlarged perspective view of the lifting device showing the location of the contact sensor, according to another embodiment of the present invention.

FIG. 17 is an enlarged perspective view of the lifting device showing the contact sensor, according to another embodiment of the present invention.

FIG. 18 is a perspective view of the lifting surface of the lifting device showing a pressure sensor mounted to the bottom of the lifting surface, according to an embodiment of the present invention.

FIG. 19 is a perspective view of a lifting device mounted to the vehicle showing the actuating assembly including a motor and one or more winches, according to another embodiment of the present invention.

FIG. 20 is a perspective view of the lifting device mounted to the vehicle showing the lifting device deployed from the cargo area of the vehicle, according to an embodiment of the present invention.

FIG. 21A is a perspective view of the lifting device mounted to the vehicle showing the lifting device tucked or stowed within the cargo area of the vehicle when not in use, stationary or before deployment, according to an embodiment of the present invention.

FIG. 21B is a perspective view of the lifting device mounted to the vehicle showing the initial state for deploying the lifting device, according to an embodiment of the present invention.

FIG. 21C is a perspective view of the lifting device mounted to the vehicle showing an intermediate state for deploying the lifting device, according to an embodiment of the present invention.

FIG. 21D is a perspective view of the lifting device mounted to the vehicle showing a final state, i.e., loading or unloading state, where the lifting surface of the lifting device is brought to contact a loading surface to enable loading the cargo to the lifting surface or unloading the cargo from the lifting surface, according to an embodiment of the present invention.

### DETAILED DESCRIPTION

A lifting device for use in a pickup trucks, vans, and other vehicles is provided. In an embodiment, the lifting device is mounted to a truck bed, for example. The lifting device has (1) a cargo rack that slides in and out of the back of a vehicle (e.g., pickup truck) and (2) a lifting (e.g., elevator) platform between an upper position of the vehicle and the ground. The cargo rack includes a sliding system with an added feature of a platform that lowers to the ground level for loading. When not loading cargo, the apparatus is not readily visible from the outside of the truck. For example, the cargo rack does not extend above the pickup bed of the truck. In use, the cargo rack slides forward and backward (in and out) of the back of the truck. The cargo rack is movable from a stowed position within the bed of the truck to a deployed position to enable loading or unloading cargo, or vice versa. To load cargo, the cargo rack is pulled out of the back of the truck. The cargo rack may extend back from the back of the track in a telescoping manner. The lifting platform can then be lowered to the ground and cargo placed on the lifting platform. The platform is raised up to the bed of the truck. The cargo rack with cargo loaded is moved into the bed of the truck. For example, the lifting device allows loading or unloading cargo to a vehicle effortlessly. In addition, the lifting device provides ready-access and convenience, as well as, improved cargo lifting capabilities. Any vehicle can be retrofitted to receive the lifting device with substantially no changes to the vehicle configuration. For vehicle applications where the load being lifted by the platform is light compared to the vehicle payload, no change is needed to the vehicle. For applications where the load is significant compared to the vehicle payload, a stiffening device can be used on the vehicle. For example, the stiffening device can a be a leveling jack or similar device that can be connected to the receiver hitch of the vehicle to the ground. For example, the leveling jack can be inserted into the hitch receiver on the vehicle and positioned vertically to the ground so as to counterbalance any force that may be exerted on the back of the vehicle by the load held on the platform of the lifting device. The leveling jack can either be removed or turned 90 degree for storage when the lifting device is not operated, when the vehicle is in motion, for example.

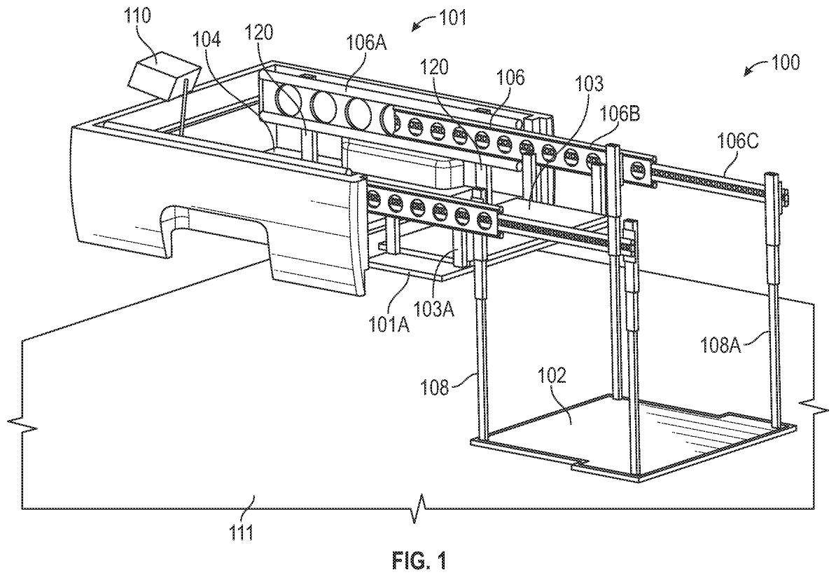

FIG. 1 is a perspective view of a lifting device 100 mounted to a vehicle 101, according to an embodiment of the present invention. The vehicle 101 can be, for example, but not limited to, a truck, a van, a trailer, a sport utility vehicle (SUV), a recreational vehicle (RV), etc. Only a portion of the vehicle 101 is shown in FIG. 1 for illustration and clarity purposes. The lifting device 100 mounted to the vehicle 101 includes a lifting surface 102 having dimensions that fit a cargo area 104 of the vehicle 101. The lifting surface 102 can be configured or sized to fit within a footprint of the cargo area 104. For example, a length and a width of the lifting surface can be smaller or almost equal a length and a width of the cargo area 104, respectively. In an embodiment, a complement surface portion 103 to the lifting surface 102 is provided to complement the lifting surface 102 so as together with the lifting surface 102 cover essentially a floor of the cargo area 104. When both the lifting surface 102 and the complement surface portion 103 are in the cargo area 104, the lifting surface 102 and the complement surface portion 103 are substantially at the same height level and form a single platform configured to receive a load. One benefit of such configuration is to provide a full flat floor at the bottom of the cargo area 104 when the lifting device is stowed away. However, in an embodiment, as will be further described in the following paragraphs, the lifting surface 102 is configured to move both horizontally and vertically while the complement surface portion 103 is configured to move only horizontally and not vertically. The complement surface portion 103 is configured to move together with the lifting surface 102 substantially horizontally and separate from the lifting surface 102 when the lifting surface 102 moves vertically. The lifting surface 102 is configured to carry a cargo (not shown). As shown in FIG. 1, the cargo area 104 can be for example a bed of a truck. The cargo area 104 can also be the cargo area of a van or the platform of a trailer, etc. In an embodiment, the lifting surface 102 is a platform. The platform is generally a planar surface and can be set substantially horizontal or slightly inclined, for example. Similarly, the complement surface portion 103 is also generally a planar surface arranged to complement the lifting surface 102 when in the cargo area 104. The lifting surface 102 is a rigid and generally a flat platform. The lifting surface 102 has a top side and a bottom side. The cargo can rest on the top side. The bottom side is configured to rest on the ground during loading or unloading when extended as shown in FIG. 1 and to rest on the floor of the vehicle within the cargo area 104 when stowed in the cargo area 104 of the vehicle 101. The lifting surface 102 can also be provided with ridges, extensions, or generally a rough profile so as to be less slippery. The lifting surface 102 can also be provided with a coating (e.g., polymer coating, rubber coating, etc.). The lifting surface 102 can be made from metal (e.g., reinforced aluminum, steel, etc.), wood, reinforced plastic, or any combination thereof. The lifting surface 102 is configured to extend to hang off the back of the vehicle 101. The lifting device 100 is shown in FIG. 1 in an extended configuration. However, as will described further in detail in the following paragraphs, the lifting device 100 can be brought into a retracted configuration so as to be fully housed within the cargo area 104 of the vehicle 101.

The lifting device 100 also includes a telescoping assembly 106 coupled to the vehicle 101 and configured to horizontally extend by telescoping further than the vehicle 101. The vehicle 101 has a footprint and the telescoping assembly 106 extends by telescoping further than the footprint of the vehicle 101. The telescoping assembly 106 is above the wheel well of the vehicle 101 and lower than the vehicle (e.g., truck) side wall so it is hidden away/tucked away in the cargo area 104. The telescoping assembly 106 is attached to the body of the vehicle 101 via braces and/or posts 120. The telescoping assembly 106 is attached to the braces and/or posts 120 are in turn attached using fasteners to the body of vehicle 101. For example, the braces and/or posts 120 can be provided within the cargo area 104 and attached to the bed of the vehicle 101, as will be described further in detail in the following paragraphs.

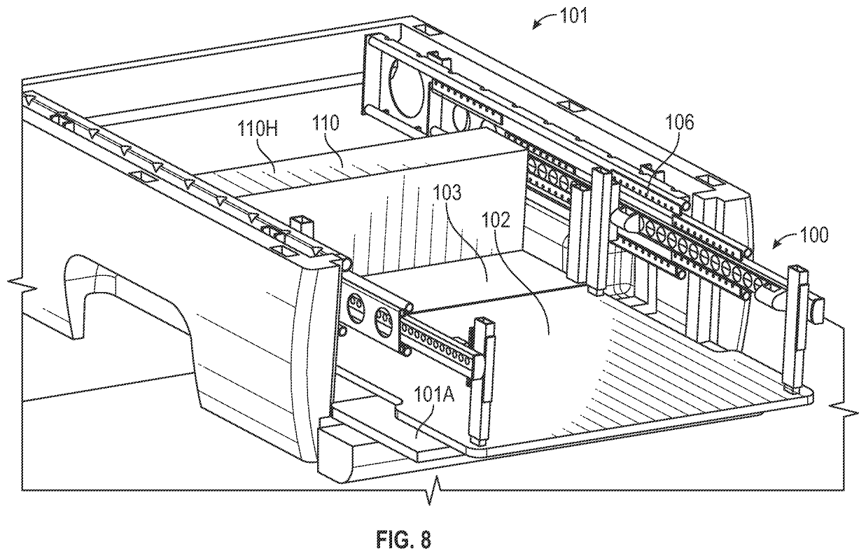

The lifting device 100 also includes a lifting mechanism 108 coupled to the telescoping assembly 106 and to the lifting surface 102. The lifting mechanism 108 is configured to move the lifting surface 102 vertically to lift or lower the lifting surface 102. The lifting surface 102 and the complement surface portion 103 are coupled to the telescoping assembly 106. The lifting surface 102 is coupled to the telescoping assembly 106 via the lifting mechanism 108 while the complement surface portion 103 is coupled to the telescoping assembly 106 via rigid arms 103A (e.g., links). The lifting device 100 also includes an actuating assembly 110 in communication with the telescoping assembly 106 and the lifting mechanism 108. In an embodiment, the actuating assembly 110 (e.g., a motor, a controller, etc.) is mechanically connected to the telescoping assembly 106 via a mechanical link or chain. FIG. 8 is a perspective view of a lifting device 100 mounted to a vehicle 101 showing the actuating assembly 110 of the lifting device 100, according to an embodiment of the present invention. In an embodiment, the actuating assembly 110 can be mounted to the complement surface portion 103 (for example, at an end of the complement surface portion 103) that is configured to move only horizontally and not vertically. In this way, the actuating assembly 110 can move horizontally with the complement surface portion 103. In an embodiment, the actuating assembly 110 can include a motor, a controller, and one or more links. As shown in FIG. 8, the actuating assembly 110 is linked to the telescoping assembly 106. In an embodiment, the lifting surface 102 can be lowered or raised using cabling stemming from an electric motor and winch arrangement of the actuating assembly 110. A housing 110H is provided to cover the actuating assembly 110 (including the motor, controller etc.) so as to keep the actuating assembly 110 covered from environmental elements (rain, snow, etc.) as well as for safety reasons. In an embodiment, the motor 110M and winch arrangement of the actuating assembly 110 is stored in the housing 110H.

The actuating assembly 110 is configured to actuate the telescoping assembly 106 to move horizontally in and out of the cargo area 104 of the vehicle 101 and to actuate the lifting mechanism 108 to move vertically down to a loading surface 111 and up to the cargo area 104 of the vehicle 101. The loading surface 111 can be the ground or other loading surface such as a floor of a hangar, the floor can be above ground level, below ground level or at the ground level. The loading surface 111 can also be a loading platform of a larger vehicle. For example, the lifting surface 102 can be lowered down to the loading surface 111 (e.g., ground) to load or unload cargo and lifted back up again. The lifting surface 102 can be raised using the lifting mechanism 108.

In an embodiment, as shown in FIG. 1, the lifting mechanism 108 includes a plurality of telescoping posts (e.g. four), for example, one or more telescoping posts can be provided on each corner of the lifting surface 102. In another embodiment, the lifting mechanism 108 may include a pair of scissor arms (not shown), each pair provided on each side of the lifting surface 102. In an embodiment, the lifting mechanism 108 includes a plurality of vertically telescoping posts 108A having provided therein a plurality of cables or straps, or both (not shown) pulled or released by the actuating assembly 110 to extend or retract the plurality of vertically telescoping posts 108A. However, the lifting mechanism 108 can be any type of lifting mechanism.

In an embodiment, as shown in FIG. 1, the telescoping assembly 106 includes telescoping elements 106A, 106B and 106C. One benefit of providing telescoping elements 106A, 106B and 106C is to achieve compactness of the lifting device 100 to stow the lifting device 100 in the cargo area 104 while enabling the lifting surface 102 to extend farther than the body of the vehicle 101. Telescoping element 106A is coupled to a body of the vehicle 101. In an embodiment, telescoping element 106A does not move as it is attached to the body of the vehicle 101 while telescoping elements 106B and 106C are configured to move relative to each other and relative to the telescoping element 106A. For example, telescoping element 106C slides inside the telescoping element 106B which in turn slides inside telescoping element 106A which is fixedly coupled to the body of the vehicle 101. Rollers or other pinions or gears, etc. (not shown in FIG. 1) can be provided between the telescoping elements 106A, 106B, 106C so as to enable smooth translation of the two telescoping elements 106A, 106B and 106C relative to each other. Although three telescoping elements 106A, 106B and 106C are shown in FIG. 1, the telescoping assembly 106 is not limited to only the telescoping elements shown and as two or more telescoping elements (e.g., 3 or 4 telescoping elements) can be used as needed. In an embodiment, the lifting mechanism 108 is coupled to the telescoping element 106C that travels farthest away from the body of the vehicle 101.

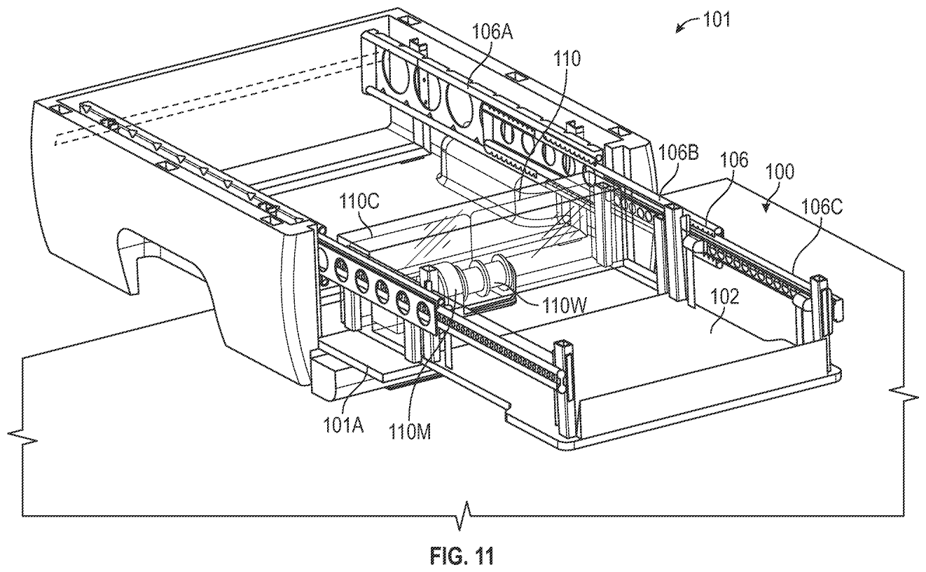

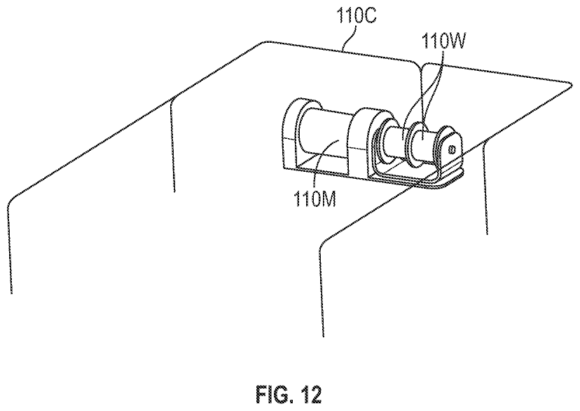

FIG. 11 is a perspective view of a lifting device 100 mounted to the vehicle 101 showing the actuating assembly 110 including motor 110M and one or more winches 110W, according to an embodiment of the present invention. FIG. 12 is schematic view of the actuating assembly 110 including the motor 110M, the one or more winches 110W, and one or more cables 110C connected the one or more winches 110W, according to an embodiment of the present invention. As shown in FIG. 11 and FIG. 12, the actuating assembly 110 includes the motor 110M coupled to the one or more winches 110W. The one or more winches 110W are driven (i.e., rotated) by the motor 110M. The one or more cables 110C are connected to the one or more winches 110W and by rotating of the one or more winches 110W using the motor 110M, the one or more cables 110C is/are wind or unwind around the one or more winches 110W, thus increasing or decreasing a length of the one or more cables 110C. The one or more cables 110C are connected to an end of the plurality of vertically telescoping posts 108A of the lifting mechanism 108. By increasing a length of the one or more cables 110C using the one or more winches 110W, the plurality of the vertically telescoping posts 108A expand relative to each other, and by decreasing the length of the one or more cables 110C using the one or more winches 110W, the plurality of vertically telescoping posts 108A retract relative to each other. In addition, by unwinding the one or more cables 110C using the one or more winches 110W actuated by the motor 110M, the telescoping elements 106A, 106B and 106C of the telescoping assembly 106 expand relative to each other and by winding the one or more cables 110C using the one or more winches 110W actuated by the motor 110M, the telescoping elements 106A, 106B and 106C retract relative to each other. Therefore, the actuating assembly 110 can be used to move the telescoping elements 106A, 106B and 106C of the telescoping assembly 106 and the plurality of vertically telescoping posts 108A of the lifting mechanism 108 and thus ultimately the lifting surface 102. Although, the lifting surface 102 is described above as being moved by using the actuating assembly 110 including the motor 110M, one or more winches 110W and one or more cables 110C, the actuating assembly 110 is not limited to the above configuration as the actuating assembly 110 can be provided with a motor and connected to the various moving parts (including the plurality of vertically telescoping posts 108A and the plurality of telescoping elements 106A, 106B and 106C) using gears or individual smaller motors can also be provided to move the one or more of the moving parts.

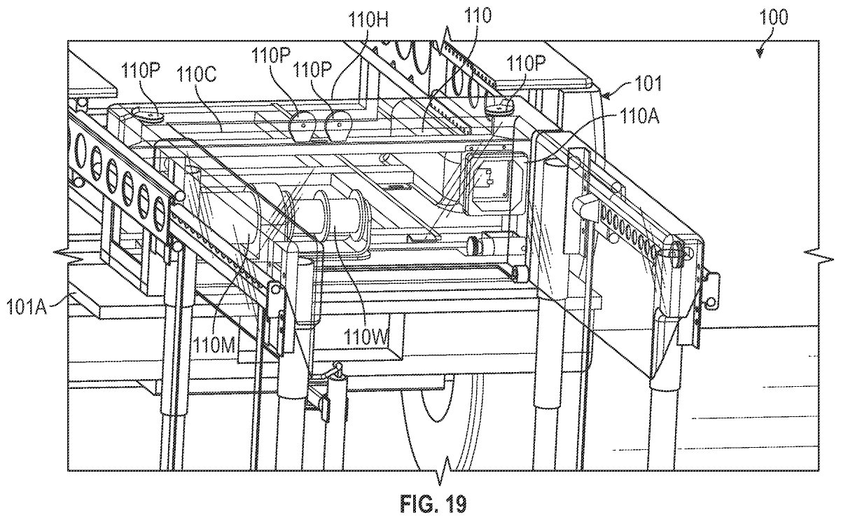

FIG. 19 is a perspective view of a lifting device 100 mounted to the vehicle 101 showing the actuating assembly 110 including motor 110M and one or more winches 110W, according to another embodiment of the present invention. This embodiment is similar in many aspects to the embodiment shown in FIG. 11. As shown in FIG. 19, the one or more cables 110C are connected to the one or more winches 110W via a plurality of pulleys 110P. The pulleys 110P are used to guide the one or more cables 110C to and/or from the one or more winches 110W connected to the motor 110M. In embodiment, the logic controller 110A is provided to control the actuating assembly 110. In an embodiment, the logic controller 110A is electromagnetically in communication with the motor 110M of the actuating assembly 110 to control the movement of the telescoping elements 106A, 106B, 106C relative to each other, and the movement of the plurality of vertically telescoping posts 108A of the lifting mechanism 108 and thus ultimately of the movement of the lifting surface 102. In an embodiment, the logic controller 110A, the motor 110M, the one or more winches 110W, and plurality of pulleys 110P are enclosed in housing 110H to protect the logic controller 110A, the motor 110M, the one or more winches 110W, and the plurality of pulleys from the environmental elements (rain, snow, sunlight, etc.).

In an embodiment, excessive angle of the vehicle 101 relative to the horizontal position, for example, front to back and/or side to side, can induce additional stress into the lifting device 100 as well as decrease the stability of the load being elevated. Significant angle of the loading surface 111 (e.g., loading platform) will induce loading 90 degrees to the vertical lifting vector that could exceed design criteria of the lifting device 100 or possibly cause some loads to shift while being lifted possibly causing shock loads to be absorbed into the structure of the lifting device 100 as well as the vehicle 101 having the lifting device 100. In an embodiment, one or more tilt sensors such as accelerometers and/or gyroscopic sensors can be mounted to the lifting device 100, for example integrated within the logic controller 110A, to constantly monitor the tilt of the lifting device 100 along two main axes (e.g., side to side and front to back) and limit/stop use of the lifting device 100 should the tilt angle of the lifting device 100 exceed predetermined limits. A signal from the one or more tilt sensors can be provided to the logic controller 110A which can monitor the angular position of the lifting device 100 and make a determination whether the lifting device 100 operates within predetermined angular limits and thus automatically stop use of the lifting device 100 when the operation of the lifting device 100 is outside the predetermined angular limits and judged not to be safe. The logic controller 110A can also provide a feedback on the safety of operation of the lifting device or other operating parameters of the lifting device 100 to the user via indicators such as flashing lights or the like and/or feedback on overall status of the logic controller 110A which can be controlled and stopped wirelessly (e.g., via a smart device or a remote controller).

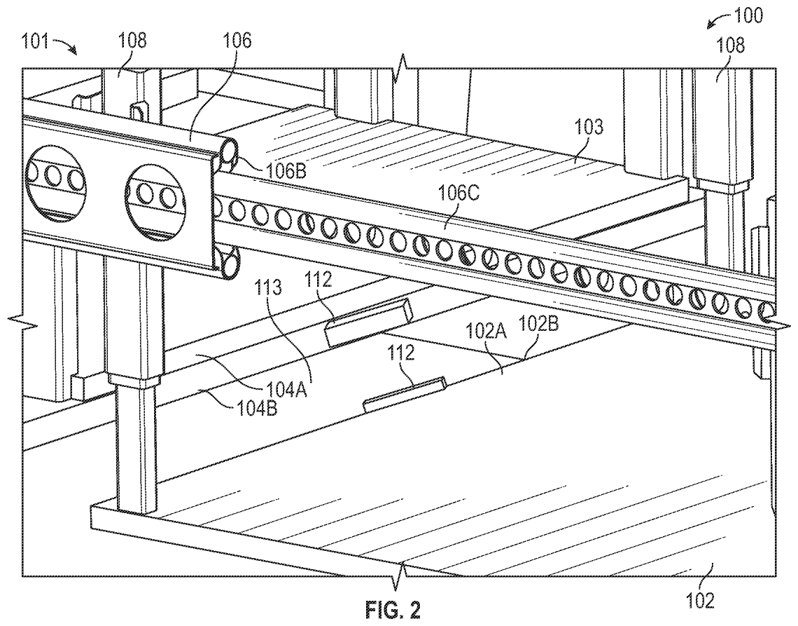

FIG. 2 is an enlarged perspective view of the lifting device 100 around a tail end 104A of the cargo area 104, according to an embodiment of the present invention. As shown in FIG. 2, the lifting device 100 also includes a contact sensor 112 positioned at a tail end 104A of the cargo area 104 of the vehicle 101 or at a back end 102A of the lifting surface 102, or both. The contact sensor 112 is in electrical communication with the actuating assembly 110 (FIG. 1). The contact sensor 112 is configured and arranged to detect when an object is caught at a pinch area 113 between an edge 104B of the tail end 104A of the cargo area 104 and an edge 102B of the back end 102A of the lifting surface 102.

In an embodiment, when the contact sensor 112 detects that an object (not shown) is caught at the pinch area 113 between the edge 104B of the tail end 104A and the edge 102B of the back end 102A of the lifting surface 102 by detecting a force exerted on the contact sensor 112, the actuating assembly 110 receives an electrical signal from the contact sensor 112 to reverse movement by a predetermined amount to relieve the force and allow the object to be removed from the pinch area 113. In an embodiment, the contact sensor 112 includes a piezoelectric sensor, a micro-switch, a limit-switch or an electromechanical sensor, or any combination thereof.

FIG. 16 is an enlarged perspective view of the lifting device 100 showing the location of the contact sensor 112, according to another embodiment of the present invention. As shown in FIG. 16, the contact sensor 112 can be positioned at a tail end 104A of the cargo area 104 of the vehicle 101.

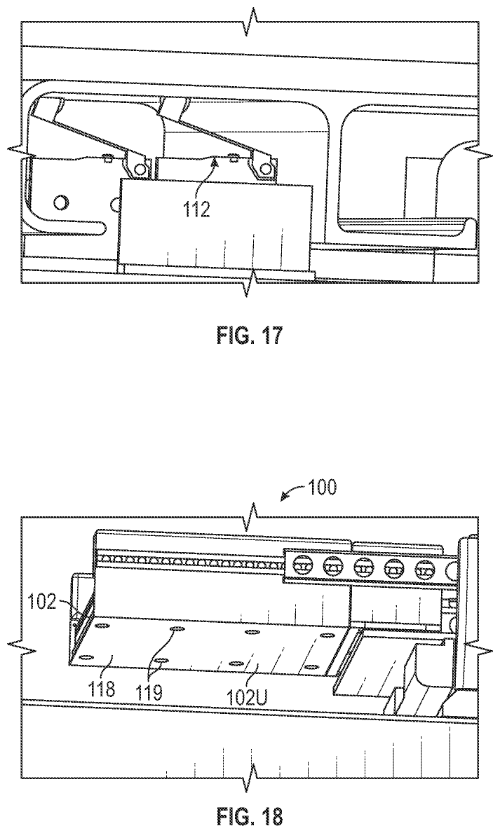

FIG. 17 is an enlarged perspective view of the lifting device 100 showing the contact sensor 112, according to another embodiment of the present invention. In this embodiment, the contact sensor 112 is a micro-switch that is configured to detect a force exerted thereupon by an object and to send an electrical signal to the actuating assembly 110 to reverse movement by a predetermined amount to relieve the force and allow the object to be removed.

The lifting surface 102 is coupled to the telescoping assembly 106 via the lifting mechanism 108 while the complement surface portion 103 is coupled to the telescoping assembly 106 via rigid arms 103A. As shown in FIG. 1, four rigid arms 103A are provided to hold the complement surface portion 103 (two rigid arms 103A on each side of the complement surface portion 103). In an embodiment, the four rigid arms 103A are coupled to the telescoping element 106B of the telescoping assembly 106. Similarly, the lifting mechanism 108 includes a plurality (e.g., four as shown in FIG. 1) of vertically telescoping posts 108A having provided therein a plurality of cables or straps, or both pulled or released by the actuating assembly 110 to extend or retract the plurality of vertically telescoping posts. For example, as shown in FIG. 1, each vertically telescoping post 108A of the lifting mechanism 108 can be attached to each corner of the lifting surface. For example, as shown in FIG. 1, the vertically telescoping posts 108A of the lifting mechanism 108 are coupled to the telescoping element 106C that travels farthest away from the body of the vehicle 101. In an embodiment, the vertically telescoping posts 108A of the lifting mechanism 108 and the rigid arms 103A are provided to slide next to each other and follow the movement of the sliding telescoping elements 106B and 106C. In this way, for example, the space occupied by the vertically telescoping posts 108A and the links or rigid arms 103A is reduced so as to maximize the space within the cargo area 104.

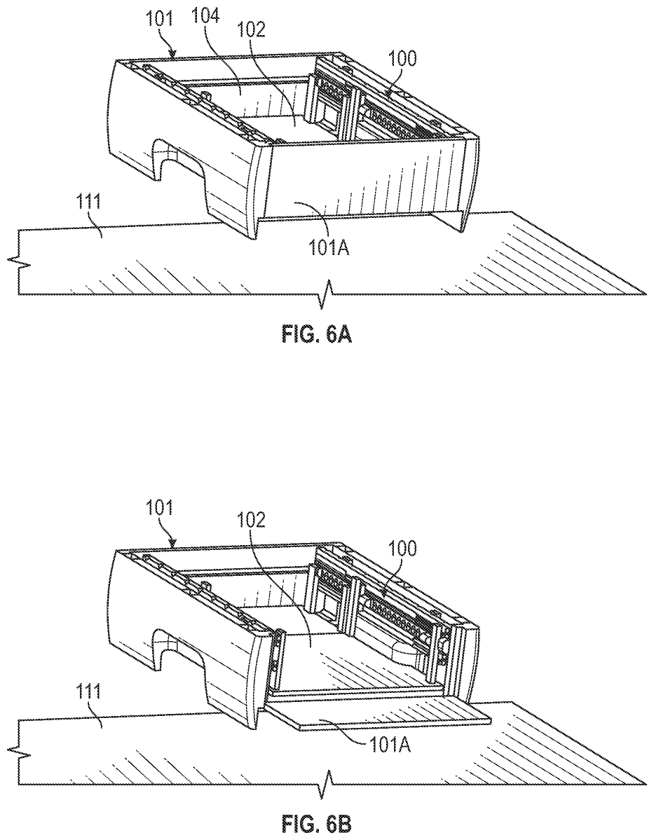

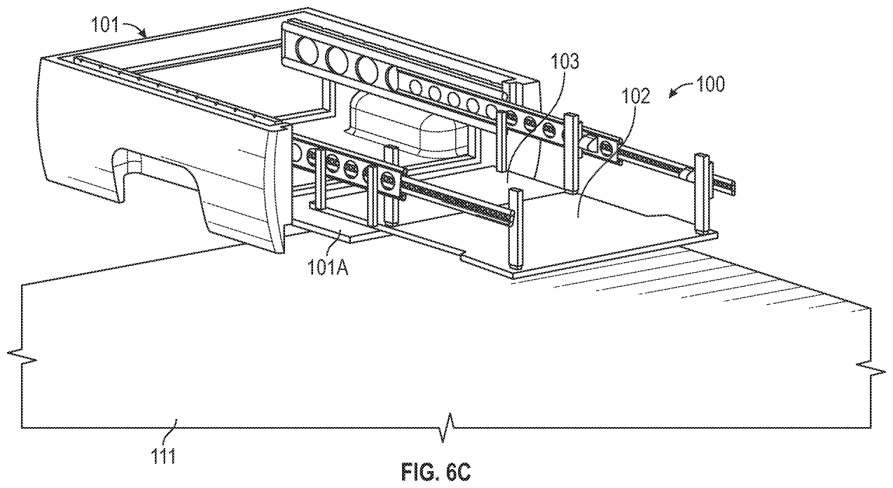

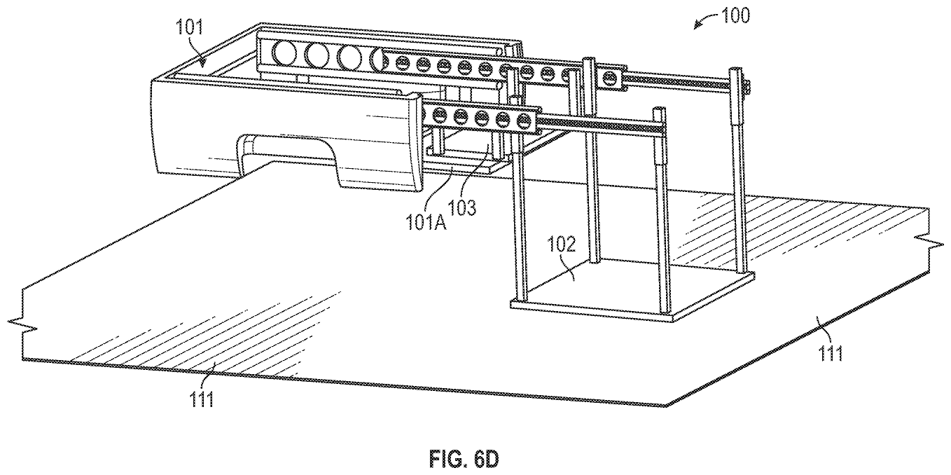

In the following paragraphs, the operation of the lifting device 100 is described in further detail. FIGS. 6A-6D are perspective views of the lifting device 100 mounted to a vehicle 101 at various stages or states of deployment of the lifting device 100, according to an embodiment of the present invention. FIG. 6A shows the lifting device 100 tucked or stowed within the cargo area 104 of the vehicle 101 when not in use, stationary or before deployment. As shown in FIG. 6A, the lifting surface 102, the complement surface portion 103, the telescoping assembly 106, and the lifting mechanism 108 are all housed within the cargo area 104 of the vehicle 101 when not in use, stationary or prior to deployment. The space occupied by the lifting surface 102, the complement surface portion 103, the telescoping assembly 106, and the lifting mechanism 108 is minimized so as to maximize the space of the cargo area 104. The space or volume of the cargo area 104 remains essentially unchanged or only slightly reduced after mounting lifting device 100 therein. In FIG. 6A, the load or cargo is not shown, however, as it can be appreciated a load can be carried by the lifting surface 102 inside the cargo area 104. FIG. 6A also depicts the tail gate 101A of the vehicle 101 enclosing the lifting device 100 within the cargo area 104.

FIG. 6B depicts the initial state for deploying the lifting device 100 wherein, for example, the cargo area 104 is opened by rotating or lowering the tail gate 101A to expose the lifting device 100 and enable the lifting surface 102 to move out of the cargo area 104.

FIG. 6C depicts an intermediate state for deploying the lifting device 100 wherein, for example, the lifting surface 102 is moved horizontally to extend out of the cargo area 104. The lifting device 100 can be deployed by actuating the actuating device (e.g., a motor) 110M. For example, an electrical switch (not shown) can be provided near the lifting device 100 or within the cabin or driving area of the vehicle 101 to actuate the actuating device (e.g., a motor) 110M. Alternatively, the actuating device (e.g., motor) 110M can be actuated remotely with a remote control, for example, using a wireless communication. The complement surface portion 103 also slides together with the lifting surface 102. In an embodiment, the complement surface portion 103 is configured to rest on top of the tail gate 101A. In an embodiment, the complement surface portion 103 is configured to hang slightly above the tail gate 101A. In an embodiment, the complement surface portion 103 is configured to cover most of the tail gate 101A.

FIG. 6D depicts a final state, i.e., loading or unloading state, where the lifting surface 102 is brought to contact the loading surface 111 to enable loading the cargo to the lifting surface 102 or unloading the cargo from the lifting surface 102. In this configuration, the complement surface portion 103 rests on the tail gate 101A and does not move vertically and is not lowered to loading surface 111. Therefore, the complement surface portion 103 is configured to move together with the lifting surface 102 substantially horizontally and separate from the lifting surface 102 when the complement surface portion 103 moves vertically. Although the lifting surface 102 is shown in FIG. 6D touching the loading surface 111, it is also contemplated that the lifting surface 102 be stopped at a certain height above the loading surface 111 if needed, for example to load a cargo that is located at a certain height above the loading surface 111.

In operation, the tail gate 101A of the vehicle 101 is opened (e.g., lowered or swung to the side, etc.), from the state shown in FIG. 6A to the state shown in FIG. 6B, and the actuating assembly 110 (FIG. 1) actuates the telescoping assembly 106 and thus the lifting surface 102 to move horizontally out of the cargo area 104 of the vehicle 101, from the state shown in FIG. 6B to the state shown in FIG. 6C. The lifting surface 102 extends out of the cargo area 104 and out of the back of the vehicle 101, from the state shown in FIG. 6B to the state shown in FIG. 6C. In an embodiment, the complement surface portion 103 moves horizontally with the lifting surface 102 until the complement surface portion 103 reaches the position of the tail gate 101A. The lifting surface 102 extends further away than the position of the tail gate 101A. The actuating assembly 110 then actuates the lifting mechanism 108 to move vertically down or lower down the lifting surface 102 to the loading surface 111, for example, in a telescoping manner or in a scissor manner, from the state shown in FIG. 6C to the state shown in FIG. 6D. The complement surface portion 103 does not move vertically with the lifting surface 102 and stays on top of the tail gate 101A. The bottom side of the lifting surface 102 is configured to rest on the loading surface 111 during loading or unloading. Cargo can then be placed on the lifting surface 102, in the state shown in FIG. 6D, and the lifting surface 102 is raised up, from the state shown in FIG. 6D to the state shown in FIG. 6C. The lifting surface 102 is then moved horizontally to the cargo area 104 of the vehicle 101, from the state shown in FIG. 6C to the state shown FIG. 6B. The tail gate 101A of the vehicle 101 is then closed (e.g., raised up), from the state shown in FIG. 6B to the state shown in FIG. 6A. The bottom side of the lifting surface 102 is configured to rest on the floor of the vehicle 101 within the cargo area 104 when stowed in cargo area 104 of the vehicle 101. Although, the lifting surface 102 is shown being extended from the back (tail side) of the vehicle 101, it is also contemplated that the lifting device 100 be configured so that the lifting surface 102 be extended from a lateral side of the vehicle 101. In this case the “tail gate” 101A is a side gate instead which is provided on the lateral side of the vehicle 101.

When not loading cargo, the lifting device 100 is not readily visible from the outside of the vehicle 101. For example, the lifting device 100 does not extend above the cargo area 104 of the vehicle 101. If the vehicle 101 is a truck, for example, the lifting device 100 does not extend above the pickup bed of the truck and thus cannot be seen from the outside of the truck. The cargo area 104 has a floor and the lifting surface 102 together with the complement surface portion 103 substantially cover the floor of the cargo area 104. In other words, the area of the lifting surface 102 and the complement surface portion 103 together is substantially equal to the area of the floor of the cargo area. The cargo area 104 only loses a relatively small area space around a perimeter of the cargo area 104. In this way, when the lifting device 100 is stowed in the cargo area 104 and is not in use, the cargo area 104 gets essentially full use as minimal (less than 10%) of area is lost in the cargo area 104 due to the addition of the lifting device 100. One benefit is that one does not have to remove the lifting device to enjoy the full use of the cargo area 104 of the vehicle 101.

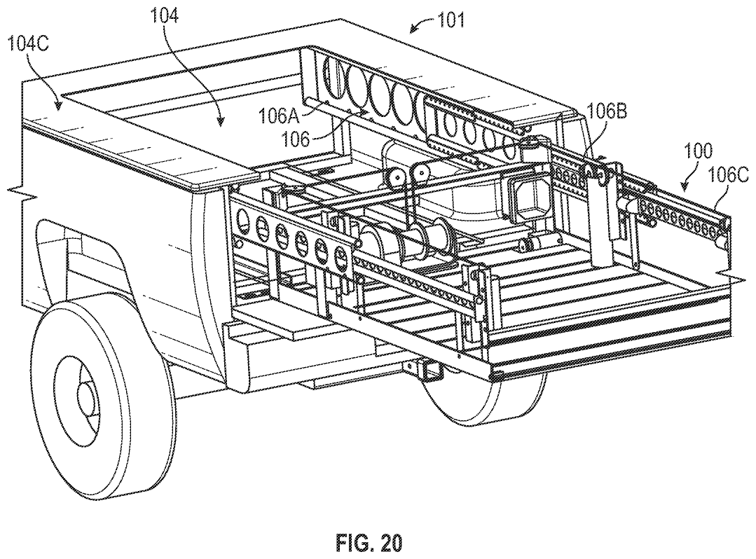

FIG. 20 is a perspective view of the lifting device 100 mounted to the vehicle 101 showing the lifting device 100 deployed from the cargo area 104 of the vehicle 101, according to an embodiment of the present invention. In an embodiment, as shown in FIG. 20, the cargo area 104 of the vehicle 101 has a U-shaped cover 104C that can be provided on a periphery of the cargo area 104 of the vehicle 101. The U-shaped cover 104C can be used to cover the telescoping assembly 106 including the telescoping elements 106A, 106B and 106C when the lifting device 100 is stowed away within the cargo area 104 of the vehicle 101.

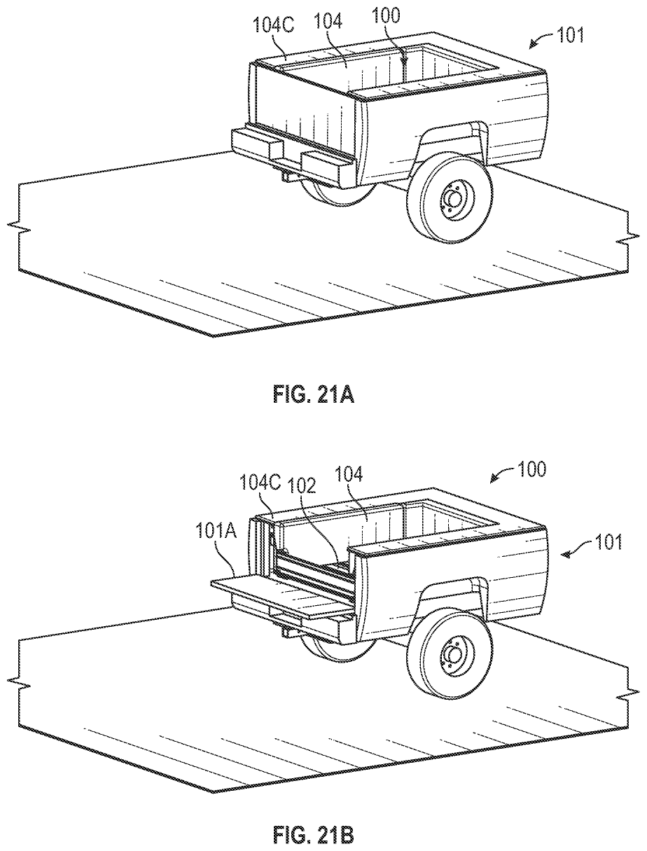

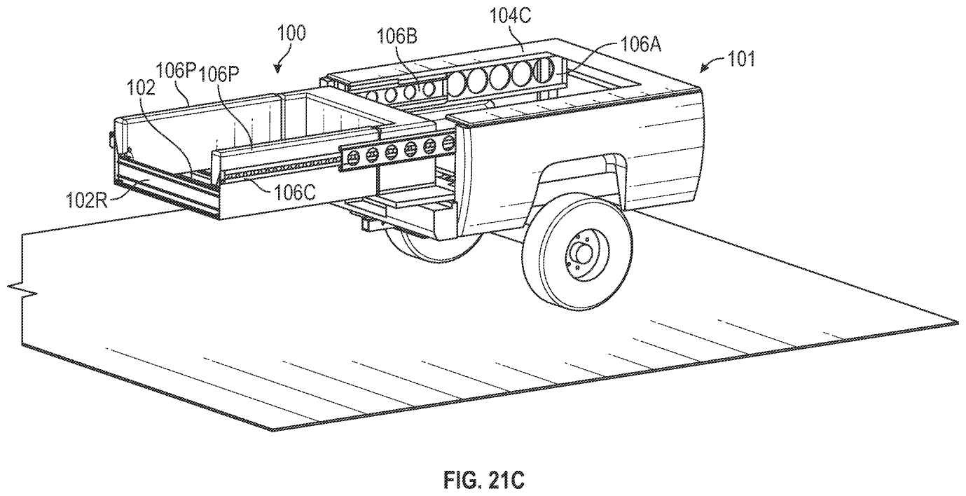

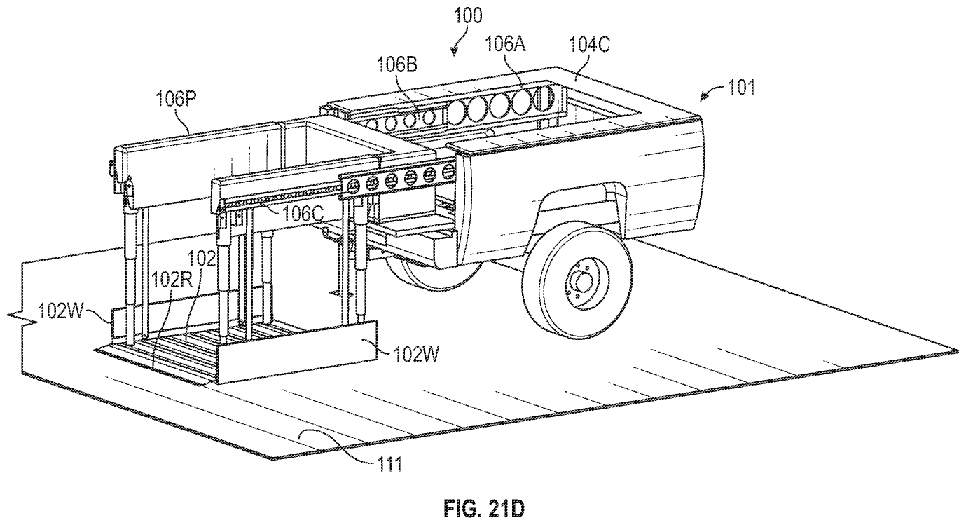

FIG. 21A is a perspective view of the lifting device 100 mounted to the vehicle 101 showing the lifting device 100 tucked or stowed within the cargo area 104 of the vehicle 101 when not in use, stationary or before deployment, according to an embodiment of the present invention. FIG. 21A shows the U-shaped cover 104C of the cargo area 104 of the vehicle 101 covering the telescoping assembly 106 (not shown in this Figure).

FIG. 21B is a perspective view of the lifting device 100 mounted to the vehicle 101 showing the initial state for deploying the lifting device 100, according to an embodiment of the present invention. For example, the cargo area 104 is opened by rotating or lowering the tail gate 101A of the vehicle 101 to expose the lifting device 100 and enable the lifting surface 102 to move out of the cargo area 104 of the vehicle 101.

FIG. 21C is a perspective view of the lifting device 100 mounted to the vehicle 101 showing an intermediate state for deploying the lifting device 100, according to an embodiment of the present invention. For example, the lifting surface 102 is moved horizontally to extend out of the cargo area 104 of the vehicle 101. As illustrated in FIG. 21C, in an embodiment, the U-shaped cover 104C of the cargo area 104 covers the telescoping element 106A while telescoping elements 106B and 106C of the telescoping assembly 106 extend to deploy the lifting device 100 including the lifting surface 102. In addition, as depicted in FIG. 21C, in an embodiment, the lifting device 100 also includes a cover 106P that is provided to cover the extending telescoping element and 106C of the telescoping assembly 106. For example, the cover 106P can protect the cargo placed in the interior area of the lifting surface 102 from potential damage by the moving telescoping assembly including telescoping elements 106B, 106C. In addition, the cover 106P can also protect the telescoping assembly 106 from potential damage by a cargo loaded on the lifting surface 102. In an embodiment, the lifting surface 102 can also be provide with a loading ramp 102R. The loading ramp 102R can be mounted to a rear edge of the lifting surface 102.

FIG. 21D is a perspective view of the lifting device 100 mounted to the vehicle 101 showing a final state, i.e., loading or unloading state, where the lifting surface 102 of the lifting device 100 is brought to contact a loading surface 111 to enable loading the cargo to the lifting surface 102 or unloading the cargo from the lifting surface 102, according to an embodiment of the present invention. In an embodiment, the lifting surface 102 can be provided with side flaps or sidewalls 102W. The side flaps or sidewall 102W of the lifting surface 102 can be mounted to the side of the lifting surface 102. The sidewalls 102W can be configured to come in contact with the cover 106P to further separate the telescoping assembly 106 from a load carried by the lifting surface 102. In an embodiment, the lifting surface 102 can also be provide with a loading ramp 102R. The loading ramp 102R can be mounted to a rear edge of the lifting surface 102.

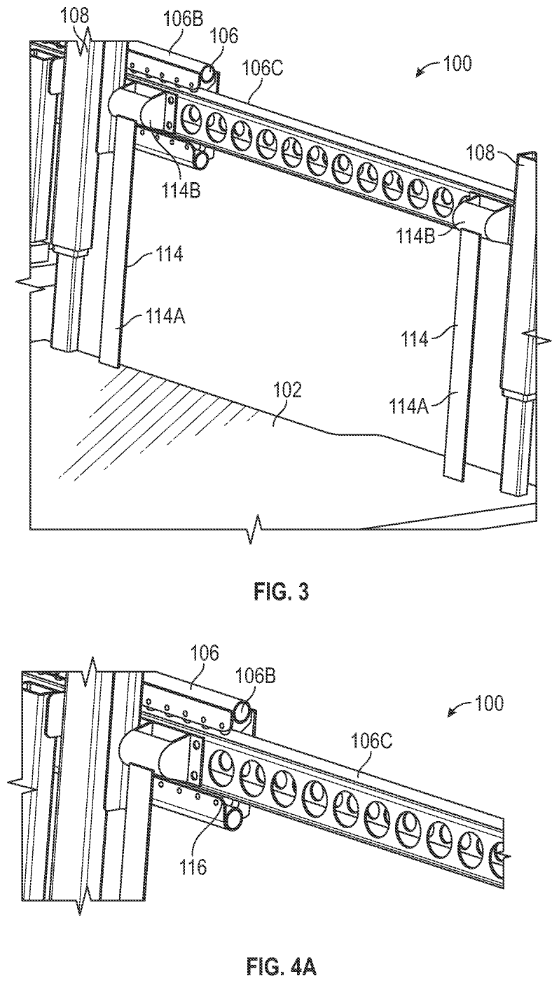

FIG. 3 is an enlarged perspective view of a portion of the lifting device 100 showing details of a safety mechanism, according to an embodiment of the present invention. In an embodiment, the lifting device 100 may also include a safety mechanism 114 attached to the telescoping assembly 106 and the lifting surface 102 to prevent the lifting surface 102 from detaching from the telescoping assembly 106 in case of failure of the lifting mechanism 108.

In an embodiment, the safety mechanism 114 includes a plurality of straps or cables 114A attached to the telescoping assembly 106 via a centrifugal clutch 114B coupled to the telescoping assembly 106 and to the lifting surface 102. The plurality of straps or cables 114A are configured to apply a lifting force by engaging the centrifugal clutch 114B due to acceleration of the lifting surface 102 due to gravity in the event of a break or accidental release or failure of the lifting mechanism 108, for example in an eventual failure of one or more of the plurality of cables within the vertically telescoping posts of the lifting mechanism 108 to prevent release of the lifting surface 102 from the telescoping assembly 106.

In an embodiment, the straps or cables 114A are spring loaded straps or cables to keep tension on the straps or cables 114A during full movement of the lifting surface 102. For example, in the event of a break in the lifting cables hidden inside telescoping posts of the lifting mechanism 108 applying the lifting force, the centrifugal clutch 114B will engage due to the acceleration of the lifting surface 102 due to gravity, thus stopping the lifting surface 102 from falling.

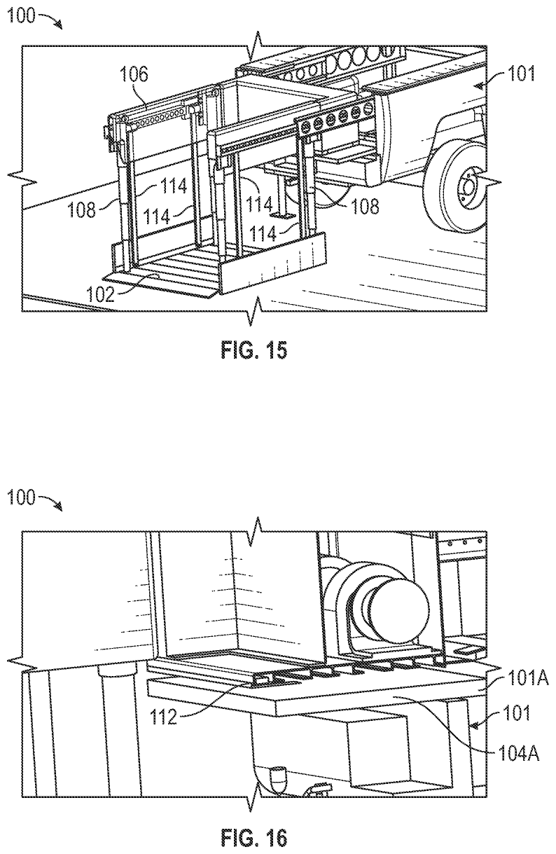

FIG. 15 is a perspective view of the lifting device 100 showing details of the safety mechanism 114, according to an embodiment of the present invention. The safety mechanism 114 attached to the telescoping assembly 106 and the lifting surface 102 to prevent the lifting surface 102 from detaching from the telescoping assembly 106 in case of failure of the lifting mechanism 108. The safety mechanism acts as a “safety brake” to stop the lifting surface 102 from suddenly dropping in case of failure of the of the lifting mechanism 108.

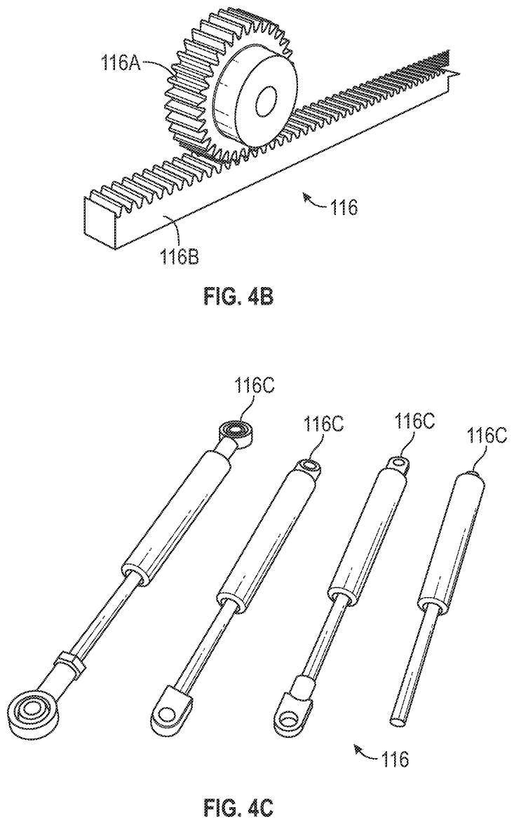

FIG. 4A is an enlarged perspective view of a portion of the lifting device 100 showing details of a dampening mechanism, according to an embodiment of the present invention. In an embodiment, the lifting device 100 includes a dampening mechanism 116 coupled to the telescoping assembly 106. The dampening mechanism 116 is configured to dampen a translation of the telescoping assembly 106.

In an embodiment, the dampening mechanism 116 includes a plurality of linear or rotary dampeners 116A and 116B or both coupled to the telescoping assembly 106. The dampening mechanism 116 is configured and arranged to soften a speed or an amount of extension or retraction of the telescoping assembly 106 to reduce an inertial force due to any heavy load provided on the lifting surface 102. For example, a heavy load is a load that is larger than 1000 lbs. (for example, 2000 lbs.).

In an embodiment, the plurality of linear or rotary dampeners 116A coupled to the telescoping assembly 106 are configured and arranged to soften a speed or an amount of extension of retraction during braking of an extension movement or during acceleration of the extension movement of the telescoping assembly 106.

In an embodiment, the dampening mechanism 116 is used so that the load on the lifting surface 102 does not impact stops at the retracted or extended positions so as to enhance longevity of the lifting device 100, operator safety and reduce chance of damage to the vehicle 101. In an embodiment, the dampening mechanism 116 can be integrated either solely or in combination with linear and rotary dampeners to “soften” the point to fully retracted and extended positions. Dampening the translation section of the telescoping range of the telescoping assembly 106 can also be used to better control heavy loads.

FIG. 4B is a perspective view of an example of a dampening mechanism 116, according to an embodiment of the present invention. In an embodiment, the dampening mechanism 116 includes rotary dampener 116A (e.g., pinion) and rack 116B can be integrated within the telescoping assembly 106 so as to provide a dampening of the relative translation of telescoping elements 106A, 106B and 106C. For example, the rack 116B can be integrated with telescoping element 106B while the rotary dampener 116A (e.g., pinion) can be integrated with the telescoping element 106C, or vice versa.

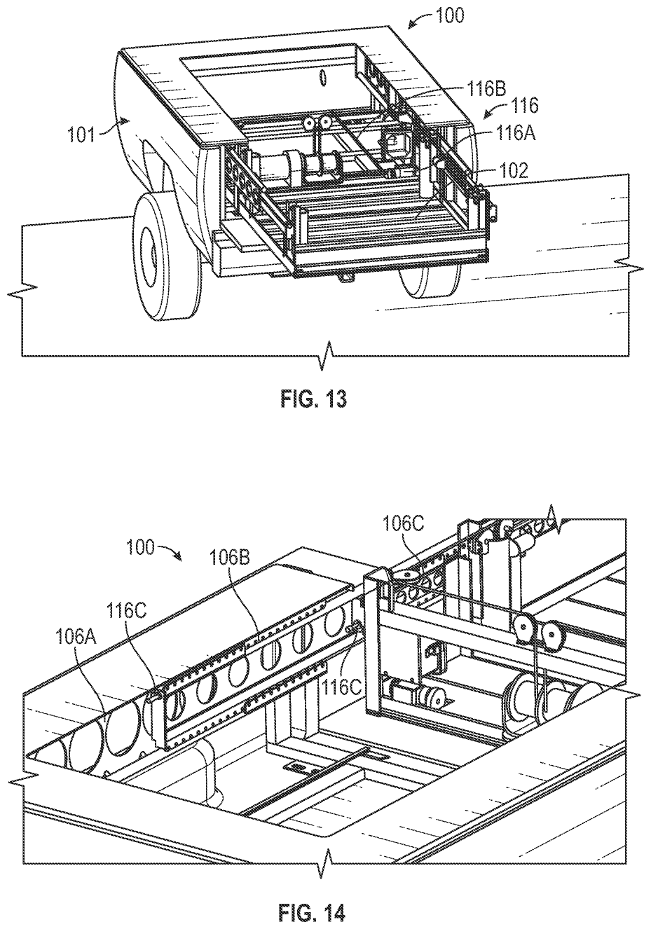

FIG. 13 is a perspective view of the lifting device 100 mounted to a vehicle 101, the lifting device 100 including dampening mechanism 116 shown in FIG. 4B, according to an embodiment of the present invention. As shown in FIG. 13, the dampening mechanism 116 including the rotary dampener 116A and the rack 116B is installed within the lifting device 100. The rack 116B is fixed relative to the vehicle 101 while the rotary dampener 116A is mounted to the moveable with the sliding lifting surface 102.

FIG. 4C is a perspective view of another example of a dampening mechanism 116, according to an embodiment of the present invention. As shown in FIG. 4C, the dampening mechanism 116 may include one or more pistons 116C provided to dampen the relative translation of telescoping elements 106B and 106C, for example. The one or more pistons 116C can be used alone or in combination with the rotary dampener 116A (e.g., pinion) and rack 116B shown in FIG. 4B.

FIG. 14 is a perspective view of the lifting device 100 mounted to a vehicle 101, the lifting device 100 including dampening mechanism 116 shown in FIG. 4C, according to an embodiment of the present invention. As shown in FIG. 14, the dampening mechanism 116 including one or more pistons 116C is installed within the lifting device 100. For example, as shown in FIG. 14, the one or more pistons 116C can be installed at an end of the telescoping elements 106B and 106C so as to dampen the relative translation of the telescoping element 106B relative to the telescoping element 106A (e.g., fixed relative to the vehicle 101) and/or to dampen the relative translation of the telescoping element 106C relative to telescoping element 106B.

Alternatively, in other embodiments, force absorbers such as springs can also be provided between the body of the vehicle 101 and the telescoping assembly 106 to reduce the speed of extension or retraction of the telescoping assembly 106, i.e., to reduce the speed of extension or retraction of telescoping elements 106B and 106C. Indeed, a spring when elongated can counteract a pulling force on the spring. In addition, a spring when compressed can also counteract the pushing force on the spring.

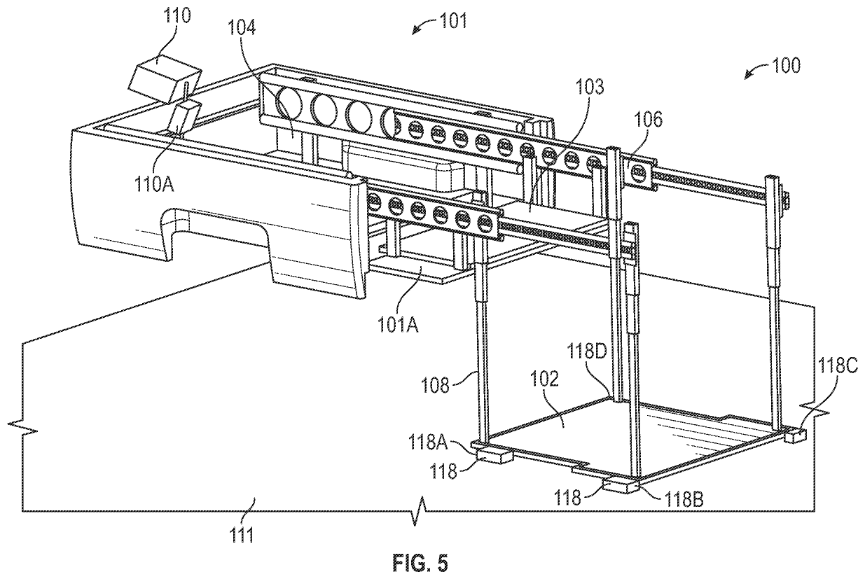

FIG. 5 is a perspective view of the lifting device 100 mounted to the vehicle 101, the lifting device 100 provided with a pressure sensor 118, according to an embodiment of the present invention. In an embodiment, as shown in FIG. 5, the pressure sensor 118 is provided underneath the lifting surface 102. The pressure sensor 118 is in electrical communication with the actuating assembly 110. The pressure sensor 118 is configured to contact an object (not shown) or the loading surface 111. When the pressure sensor 118 comes in contact with the loading surface 111 or the object, the pressure sensor 118 sends an electrical signal to the actuating assembly 110 to stop a lowering movement of the lifting mechanism 108.

In an embodiment, the pressure sensor 118 includes a plurality of pressure sensitive elements 118A, 118B, 118C and 118D arranged underneath the lifting surface 102. The pressure sensitive elements 118A, 118B, 118C and 118D can be arranged at the four corners of the lifting surface 102, respectively. The plurality of pressure sensitive elements 118S, 118B, 118C and 118D are in communication with a logic controller 110A. When a first pressure sensitive element (e.g., pressure sensitive element 118A) in the plurality of pressure sensitive elements 118A, 118B, 118C, 118D touches the loading surface 111 while a second pressure sensitive element (e.g., pressure sensitive element 118C) in the plurality of pressure sensitive elements 118A, 118B, 118C, 118D does not touch the loading surface 111, a determination is made by the logic controller 110A that the lifting surface 102 is not evenly contacting the loading surface 111 and an alert message is emitted by the logic controller 110A. Alternatively or in addition, when the first pressure sensitive element (e.g., pressure sensitive element 118A) in the plurality of pressure sensitive elements 118A, 118B, 118C, 118D touches the loading surface 111 while the second pressure sensitive element (e.g., pressure sensitive element 118C) in the plurality of pressure sensitive elements 118A, 118B, 118C, 118D does not touch the loading surface 111, a determination is made by the logic controller 110A that the lifting surface 102 is not evenly contacting the loading surface 111 and an electromagnetic signal (electric signal or wireless signal) is sent by the logic controller 110A (which is electromagnetically in communication with the actuating assembly 110) to the actuating assembly 110 to stop the lowering movement of the lifting mechanism 108 and thus stop lowering the lifting surface 102.

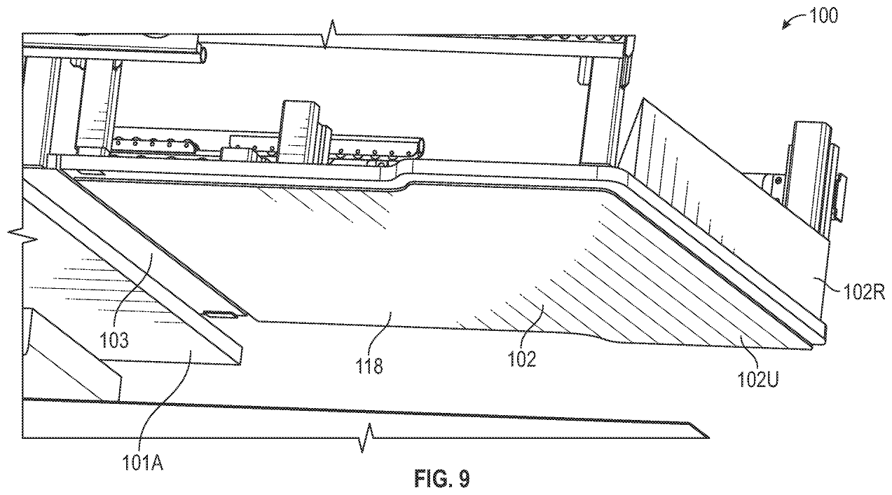

FIG. 9 is a perspective view of the lifting surface 102 of the lifting device 100 showing a pressure sensor 118 mounted to the bottom 102U of the lifting surface 102, according to an embodiment of the present invention. In an embodiment, as shown in FIG. 9, a single pressure sensor 118 can also be used such as a pressure pad, mirroring the general shape of the lifting surface 102. The pressure sensor 118 (e.g., pressure pad) can include an array of limit switches that covers the bottom 102U of the lifting surface 102 to detect unequal impacts or touches on the loading surface 111. In an embodiment, the lifting surface 102 can also be provide with a loading ramp 102R. The loading ramp 102R can be mounted to a rear edge of the lifting surface 102.

FIG. 18 is a perspective view of the lifting surface 102 of the lifting device 100 showing a pressure sensor 118 mounted to the bottom 102U of the lifting surface 102, according to an embodiment of the present invention. For example, as shown in FIG. 18, pressure sensor 118 can be a single pressure pad or pressure plate mounted to the bottom 102U of the lifting surface 102. A plurality of fasteners 119 (e.g., screws) can be used to fasten the pressure sensor 118 to the bottom 102U of the lifting surface 102 of the lifting device 100. Although the pressure sensor 118 is shown as one single unitary pressure plate, the pressure sensor 118 is not limited to only this configuration but can be provided as a plurality of pressure plates, for example. In an embodiment, the pressure sensor 118 (e.g., pressure plate) can be configured to sense a pressure point (for example an object) and thus a position where the pressure point originates from below the pressure sensor 118 can be determined.

One benefit of providing a pressure sensor 118 is to error proof against lowering the lifting surface 102 onto an object thus inhibiting the lifting surface 102 from uniformly contacting the ground.

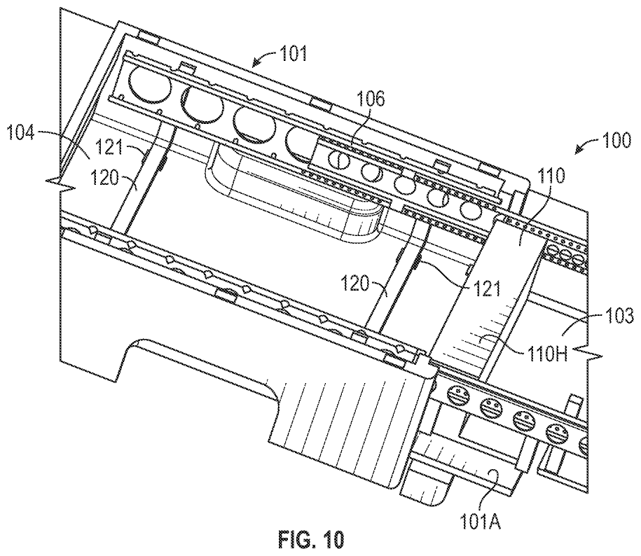

FIG. 10 is perspective top view of the lifting device 100 mounted to the vehicle 101, according to an embodiment of the present invention. As shown in FIG. 10, the lifting device 100 is mounted to the body (e.g., frame rails) of the vehicle 101 using braces 120 that are fastened to the body (e.g., frame rails) of the vehicle 101 using a plurality of fasteners 121 (e.g., bolts, etc.). For example, the braces 120 can be fastened to the frame rails of the vehicle 101 using the same anchor points as the cargo area 104 uses in its current state. In an embodiment, the fasteners 121 can be large conventional bolts or other types of fasteners adapted to hold the braces 120 (e.g., the cross members) of the lifting device 100 to the frame of vehicle 101. In an embodiment, the braces 120 (e.g., the cross members) are also coupled to the telescoping assembly 106 to hold the lifting device 100 in place. Specifically, the braces 120 are coupled to the telescoping element 106A which is fixed and does not move. The attachment system including the braces 120 and fasteners 121, etc. of the lifting device 100 to the vehicle 101 allows the lifting device to be easily removed or mounted to the vehicle 101 as needed. For example, the lifting device 100 can be removed by removing fasteners and/or braces and disconnecting a power supply of the lifting device 100 from the electrical system of vehicle 101. One benefit of the present configuration is that removal of the lifting device 100 from the vehicle 101 is easier than typical conventional tailgate lifts. In addition, the outward look of the vehicle 101 remains unchanged by the addition of the lifting device 100 which can be a selling point in the retail market. Furthermore, the lifting device 100 can be provided in the cargo area 104 of the vehicle 101 relatively unobtrusively while keeping most of the volume or surface area the cargo area (e.g., truck bed) available for cargo use.

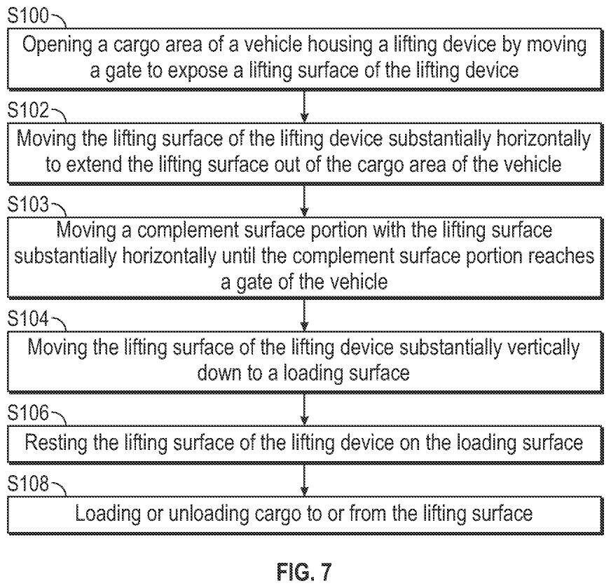

Another aspect of the present invention is to provide a method of loading or unloading a load into or from a vehicle 101 using the lifting device 100. FIG. 7 is a flow chart of the method of loading or unloading cargo into or from the vehicle 101 using the lifting device 100, according to an embodiment of the present invention. The method includes opening a cargo area 104 of the vehicle housing the lifting device 100 by moving a gate to expose a lifting surface of the lifting device 100, at S100. The method further includes moving the lifting surface of the lifting device 100 substantially horizontally to extend the lifting surface out of the cargo area 104 of the vehicle 101, at S102. The method also includes moving the lifting surface of the lifting device 100 substantially vertically down to a loading surface, at S104. The method includes resting the lifting surface of the lifting device 100 on the loading surface, at S106; and loading or unloading the cargo to or from the lifting surface, at S108.

In an embodiment, the method further includes moving a complement surface portion 103 with the lifting surface substantially horizontally until the complement surface portion reaches the gate, at S103. In an embodiment, resting the complement surface portion 103 on top of the gate while continue moving the lifting surface vertically.

In an embodiment, moving the lifting surface of the lifting device substantially horizontally includes actuating a telescoping assembly of the lifting device using an actuating assembly of the lifting device. In an embodiment, moving the lifting surface of the lifting device substantially horizontally includes moving the lifting surface out of the cargo area of the vehicle and out of a rear end of the vehicle or a lateral side of the vehicle. In an embodiment, moving the lifting surface of the lifting device substantially vertically includes actuating a lifting mechanism to move vertically down the lifting surface. In an embodiment, opening the cargo area of the vehicle housing the lifting device by moving the gate includes lowering the gate located at a back or a side of the vehicle.

In an embodiment, the method further includes after resting the lifting surface of the lifting device on the loading surface, sensing that the lifting surface touches evenly the loading surface using a plurality of sensors provided at different locations on the lifting surface. In an embodiment, the method also includes raising up the lifting surface to a level of the cargo area of the vehicle and moving horizontally the lifting surface to the cargo area of the vehicle.

Only exemplary embodiments of the present invention and but a few examples of its versatility are shown and described in the present disclosure. It is to be understood that the present invention is capable of use in various other combinations and environments and is capable of changes or modifications within the scope of the inventive concept as expressed herein.

Although the foregoing description is directed to the preferred embodiments of the invention, it is noted that other variations and modifications will be apparent to those skilled in the art, and may be made without departing from the spirit or scope of the invention. Moreover, features described in connection with one embodiment of the invention may be used in conjunction with other embodiments, even if not explicitly stated above.

We claim:

1. A lifting device for mounting to a vehicle, comprising:
a lifting surface having dimensions that fit a cargo area of the vehicle, the lifting surface being configured to carry a cargo;
a telescoping assembly coupled to the vehicle and configured to horizontally extend by telescoping further than the vehicle;
a lifting mechanism coupled to the telescoping assembly and to the lifting surface, the lifting mechanism being configured to move the lifting surface vertically to lift or lower the lifting surface; and
an actuating assembly in communication with the telescoping assembly and the lifting mechanism, the actuating assembly being configured to actuate the telescoping assembly to move horizontally in and out of the cargo area of the vehicle and to actuate the lifting mechanism to move vertically down to a loading surface and up to the cargo area of the vehicle.

2. The lifting device according to claim 1, further comprising a contact sensor positioned at a tail end of the cargo area of the vehicle or at a back end of the lifting surface, or both, and in electrical communication with the actuating assembly, the contact sensor being configured and arranged to detect when an object is caught at a pinch area between an edge of the tail end and an edge of the back end of the lifting surface.

3. The lifting device according to claim 2, wherein when the contact sensor detects that the object is caught at the pinch area between the edge of the tail end and the edge of the back end of the lifting surface by detecting a force exerted on the contact sensor, the actuating assembly receives an electrical signal from the contact sensor to reverse movement by a predetermined amount to relieve the force and allow the object to be removed from the pinch area.

4. The lifting device according to claim 2, wherein the contact sensor comprises a micro-switch, a limit-switch, an electromechanical sensor, or a piezoelectric sensor, or any combination thereof.

5. The lifting device according to claim 1, wherein the lifting surface is made from metal, wood or plastic, or any combination thereof.

6. The lifting device according to claim 1, wherein the lifting mechanism comprises a plurality of vertically telescoping posts or a pair of scissor arms.

7. The lifting device according to claim 1, further comprising a complement surface portion configured to move together with the lifting surface substantially horizontally and configured to separate from the lifting surface when the lifting surface moves vertically.

8. The lifting device according to claim 1, further comprising a safety mechanism attached to the telescoping assembly and the lifting surface to prevent the lifting surface from detaching from the telescoping assembly in case of failure of the lifting mechanism.

9. The lifting device according to claim 8, wherein the lifting mechanism comprises a plurality of vertically telescoping posts, and wherein the safety mechanism includes a plurality of straps or cables attached to the telescoping assembly via a centrifugal clutch coupled to the telescoping assembly and to the lifting surface, wherein the plurality of straps or cables are configured to apply a lifting force by engaging the centrifugal clutch due to acceleration of the lifting surface due to gravity in an event of a break or accidental release or failure of one or more of the plurality of straps or cables within the plurality of vertically telescoping posts to prevent release of the lifting surface from the telescoping assembly.

10. The lifting device according to claim 1, wherein the lifting mechanism comprises a plurality of vertically telescoping posts having provided therein a plurality of cables or straps pulled or released by the actuating assembly to extend or retract the plurality of vertically telescoping posts.

11. The lifting device according to claim 1, further comprising a dampening mechanism coupled to the telescoping assembly, the dampening mechanism being configured to dampen a translation of the telescoping assembly.

12. The lifting mechanism according to claim 11, wherein the dampening mechanism comprises a plurality of linear or rotary dampeners or both coupled to the telescoping assembly and configured and arranged to soften a speed or an amount of extension or retraction of the telescoping assembly to reduce an inertial force due to any heavy load provided on the lifting surface.

13. The lifting mechanism according to claim 12, wherein the plurality of linear or rotary dampeners coupled to the telescoping assembly are configured and arranged to soften a speed or an amount of extension of retraction during braking of an extension movement or during acceleration of the extension movement of the telescoping assembly.

14. The lifting device according to claim 1, further comprising a pressure sensor provided underneath the lifting surface, the pressure sensor being in electrical communication with the actuating assembly, the pressure sensor being configured to contact an object or the loading surface or both,
wherein when the pressure sensor comes in contact with the loading surface or the object the pressure sensor sends an electrical signal to the actuating assembly to stop a lowering movement of the lifting mechanism.

15. The lift device according to claim 14, wherein the pressure sensor comprises a plurality of pressure sensitive elements arranged underneath the lifting surface, wherein the plurality of pressure sensitive elements are in communication with a logic controller and when a first pressure sensitive elements in the plurality of pressure sensitive elements touches the loading surface while a second pressure sensitive element in the plurality of pressure sensitive elements does not touch the loading surface, a determination is made by the logic controller that the lifting surface is not evenly contacting the loading surface and an alert message is emitted by the logic controller.

16. The lift device according to claim 15, wherein the pressure sensor comprises a plurality of pressure sensitive elements arranged underneath the lifting surface, wherein the plurality of pressure sensitive elements are in communication with a logic controller and when a first pressure sensitive elements in the plurality of pressure sensitive elements touches the loading surface while a second pressure sensitive element in the plurality of pressure sensitive elements does not touch the loading surface, a determination is made by the logic controller that the lifting surface is not evenly contacting the loading surface and the logic controller sends an electromagnetic signal to the actuating assembly to stop the lowering movement of the lifting mechanism.

17. A method of loading or unloading cargo into and from a vehicle using a lifting device, the method comprising:
opening a cargo area of the vehicle housing a lifting device by moving a gate to expose a lifting surface of the lifting device;
moving the lifting surface of the lifting device substantially horizontally to extend the lifting surface out of the cargo area of the vehicle;
moving the lifting surface of the lifting device substantially vertically down to a loading surface;
resting the lifting surface of the lifting device on the loading surface; and
loading or unloading cargo to or from the lifting surface.

18. The method according to claim 17, wherein moving the lifting surface of the lifting device substantially horizontally comprises actuating a telescoping assembly of the lifting device using an actuating assembly of the lifting device.

19. The method according to claim 17, wherein moving the lifting surface of the lifting device substantially horizontally comprises moving the lifting surface out of the cargo area of the vehicle and out of a rear end of the vehicle or a lateral side of the vehicle.

20. The method according to claim 17, wherein moving the lifting surface of the lifting device substantially vertically comprises actuating a lifting mechanism to move vertically down the lifting surface.

21. The method according to claim 17, wherein opening the cargo area of the vehicle housing the lifting device by moving the gate comprises lowering the gate located at a back or a side of the vehicle.

22. The method according to claim 17, further comprising, after resting the lifting surface of the lifting device on the loading surface, sensing that the lifting surface touches evenly the loading surface using a plurality of sensors provided at different locations on the lifting surface.

23. The method according to claim 17, further comprising raising up the lifting surface to a level of the cargo area of the vehicle and moving horizontally the lifting surface to the cargo area of the vehicle.

24. The method according to claim 17, further comprising moving a complement surface portion along with the lifting surface substantially horizontally until the complement surface portion reaches the gate, and resting the complement surface portion on top of the gate while continue moving the lifting surface vertically.
